(19) United States
(12) Patent Application Publication
(10) Pub. No.: US 2025/0363042 A1
(43) Pub. Date: Nov. 27, 2025

(54) HOST-IMPLEMENTED MEMORY OPERATION PROCEDURES

(71) Applicant: Micron Technology, Inc., Boise, ID (US)

(72) Inventors: Marco DI PASQUA, Napoli (IT); Gianluca COPPOLA, Saviano (IT)

(21) Appl. No.: 19/088,351

(22) Filed: Mar. 24, 2025

Related U.S. Application Data
(60) Provisional application No. 63/650,208, filed on May 21, 2024.

(51) Int. Cl. G06F 11/3668

(52) U.S. Cl. CPC G06F 11/3688; G06F 11/3692

(57) ABSTRACT

In some implementations, a host device may receive an instruction to execute a command relating to a memory apparatus. The host device may identify a memory operation procedure that corresponds to the command, where the memory operation procedure combines a plurality of memory commands supported by a firmware of the memory apparatus, and where the memory operation procedure is unavailable through the firmware of the memory apparatus. The host device may transmit the plurality of memory commands to the memory apparatus. The host device may receive a plurality of responses from the memory apparatus relating to an execution of the plurality of memory commands by the memory apparatus.

### CROSS-REFERENCE TO RELATED APPLICATION

This patent application claims priority to U.S. Provisional Patent Application No. 63/650,208, filed on May 21, 2024, entitled “HOST-IMPLEMENTED MEMORY OPERATION PROCEDURES,” and assigned to the assignee hereof. The disclosure of the prior application is considered part of and is incorporated by reference into this patent application.

### TECHNICAL FIELD

The present disclosure generally relates to memory devices, memory device operations, and, for example, to host-implemented memory operation procedures.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of host-implemented memory operation procedures.

FIG. 2 is a diagram of an example of host-implemented memory operation procedures.

FIG. 3 is a flowchart of an example method associated with host-implemented memory operation procedures.

FIG. 4 is a flowchart of an example method associated with host-implemented memory operation procedures.

### DETAILED DESCRIPTION

A memory device may have embedded firmware for the operation and maintenance of the memory device. Developing firmware for a memory device may entail incorporating complex features to satisfy diverse requirements and/or to address specific nuances of memory operations. However, implementing complex features directly within the firmware can be an intricate and inefficient process, involving extensive design and validation phases that hinder the evolution of memory technology. In some cases, after firmware is deployed, bugs or issues associated with the firmware may be discovered. Timely updates to the firmware to fix these issues can be complicated due to the embedded nature of the firmware as well as firmware architecture constraints, and may require additional layers of design and validation.

Some implementations described herein allow the functionality of a memory device to be extended simply and efficiently by enabling the execution of complex features and procedures that are not natively supported by the memory device's firmware. In some implementations, a host device may execute a software tool that configures complex memory operation procedures that each combine multiple basic memory commands. The host device, through a software interface, may receive an instruction to execute a command with respect to a memory device. The command may correspond to a memory operation procedure that, while not natively supported by the memory device's firmware, combines multiple memory commands that are natively supported by the memory device's firmware. Accordingly, the host device may issue the multiple memory commands to the memory device to thereby carry out the memory operation procedure. The memory operation procedure may facilitate diagnostic analysis of the memory device and/or may provide a workaround to known bugs or issues in the memory device's firmware.

In this way, the implementation of complex features and procedures is moved from the embedded memory firmware to software on the host system, thereby reducing the complexity, resource needs, and time required to design and validate new memory features and procedures. By decoupling the memory operation procedures from the firmware, techniques described herein increase the adaptability of a system to changes or additions of functionalities without requiring comprehensive firmware overhauls. Moreover, techniques described herein enable efficient deployment of updates to quickly address known bugs or issues in firmware.

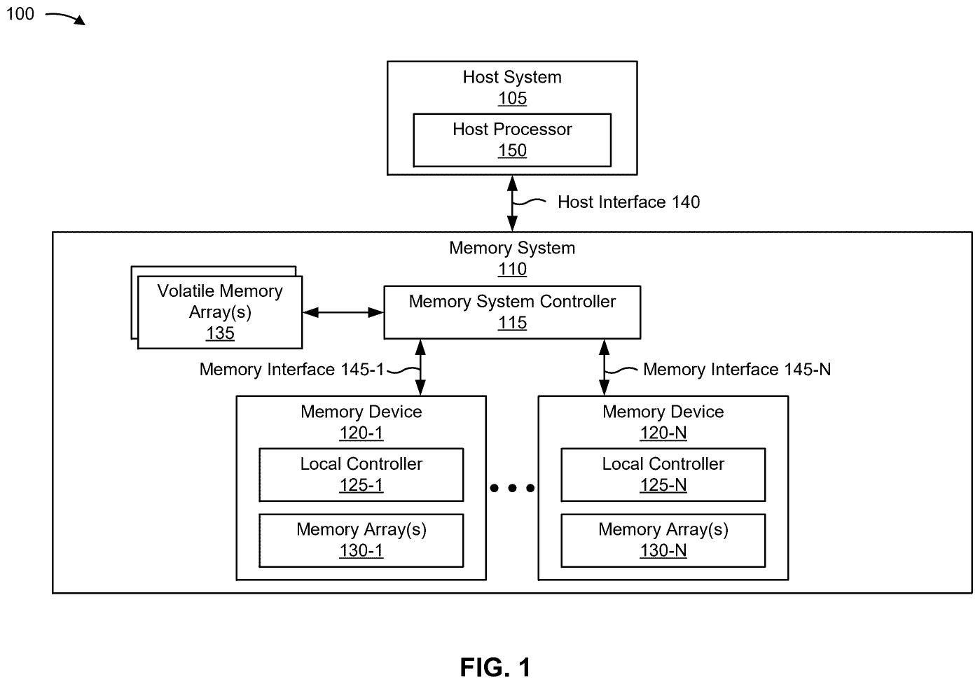

FIG. 1 is a diagram illustrating an example system 100 capable of host-implemented memory operation procedures. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a universal flash storage (UFS) system, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive an instruction to execute a command relating to a memory apparatus; identify a memory operation procedure that corresponds to the command, wherein the memory operation procedure combines a plurality of memory commands supported by a firmware of the memory apparatus, and wherein the memory operation procedure is unavailable through the firmware of the memory apparatus; transmit the plurality of memory commands to the memory apparatus; and receive a plurality of responses from the memory apparatus relating to an execution of the plurality of memory commands by the memory apparatus.

In some implementations, one or more systems, devices, apparatuses, components, and/or controllers of FIG. 1 may be configured to receive an instruction to execute a command relating to a memory apparatus; transmit, to the memory apparatus, a plurality of memory commands of a memory operation procedure corresponding to the command, wherein the memory operation procedure is unsupported natively by the memory apparatus, and wherein the plurality of memory commands are supported natively by the memory apparatus; and receive a plurality of responses from the memory apparatus relating to an execution of the plurality of memory commands by the memory apparatus.

In some implementations, one or more systems, devices, apparatuses, components, and/or controllers of FIG. 1 may be configured to receive an instruction to execute a command; identify a memory operation procedure that corresponds to the command, wherein the memory operation procedure combines a plurality of memory commands; and transmit the plurality of memory commands, and/or may be configured to receive the plurality of memory commands; execute the plurality of memory commands; and transmit a plurality of responses relating to an execution of the plurality of memory commands.

In some implementations, one or more systems, devices, apparatuses, components, and/or controllers of FIG. 1 may be configured to receive an instruction to execute a command relating to a memory apparatus; transmit a plurality of memory commands of a memory operation procedure corresponding to the command, wherein the memory operation procedure is unavailable through a firmware of the memory apparatus; receive information from the memory apparatus relating to an execution of the plurality of memory commands by the memory apparatus; and analyze the information to generate diagnostic data related to the memory apparatus.

In some implementations, one or more systems, devices, apparatuses, components, and/or controllers of FIG. 1 may be configured to receive, from a host device, a plurality of memory commands of a memory operation procedure, wherein the memory operation procedure is unsupported natively; and execute the plurality of memory commands.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

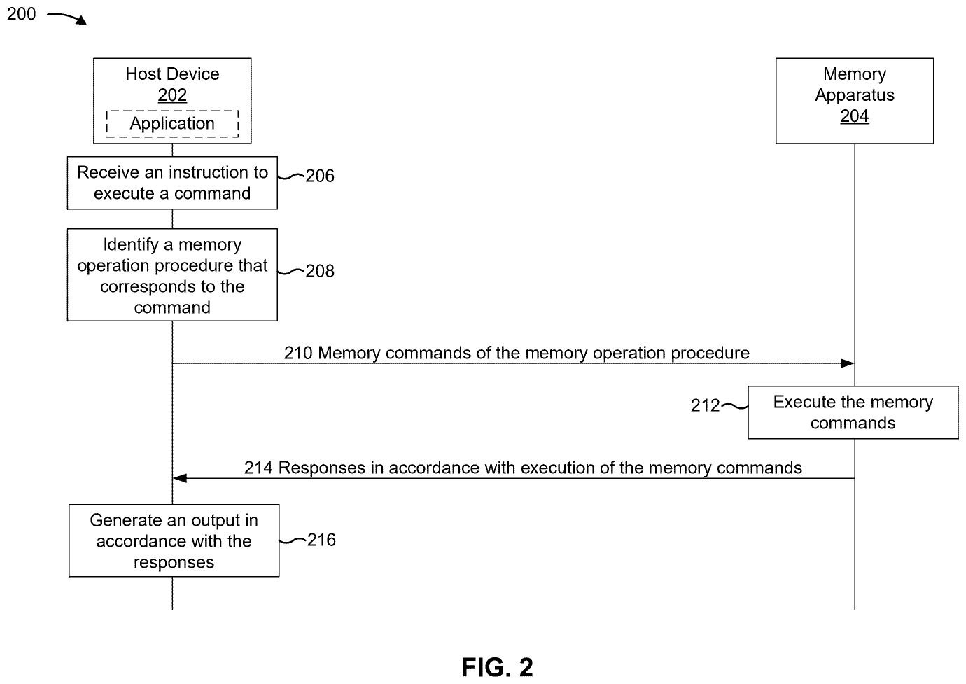

FIG. 2 is a diagram of an example 200 of host-implemented memory operation procedures. As shown, example 200 includes a host device 202 and a memory apparatus 204. The host device 202 may correspond to or may include the host system 105 and/or the host processor 150. The host device 202 may implement an application (e.g., a user software tool) that configures one or more memory operation procedures (e.g., test flows, procedure flows, or the like). Each memory operation procedure may combine (e.g., in a sequence) a plurality of memory operations. Each memory operation procedure may be run on the host device 202 using a single command made through the application. The memory apparatus 204 may correspond to or may include the memory system 110, the memory system controller 115, a memory device 120, and/or a local controller 125. In some implementations, the memory apparatus 204 may include a managed NAND (mNAND) memory device. The memory apparatus 204 may implement firmware that is configured to support multiple memory commands.

As shown by reference number 206, the host device 202 may receive an instruction to execute a command (e.g., a single command, thereby simplifying usage at a user side) relating to the memory apparatus 204. For example, the command may be run via the application, thereby resulting in the host device 202 receiving the instruction to execute the command. In some implementations, the instruction to run the command may be based on a user input to a user interface associated with the application. In some implementations, the instruction to run the command may be generated automatically by the host device 202 or other system according to a configured time interval or in response to an event (e.g., powering on or restarting the host device 202 and/or the memory apparatus 204).

As shown by reference number 208, in response to receiving the command, the host device 202 (e.g., using the application) may identify a memory operation procedure (e.g., a single test flow or procedure flow) that corresponds to the command. For example, each memory operation procedure configured in the application may be called using a respective command. The memory operation procedure may combine a plurality of memory commands (e.g., in a particular sequence). For example, the memory commands may be basic commands that are combined into a more complex memory operation procedure. The command and the memory operation procedure may be unsupported natively by the memory apparatus 204. For example, the memory operation procedure may be a non-native operation of the memory apparatus 204. As an example, the memory operation procedure may be unavailable through the firmware of the memory apparatus 204 (e.g., the memory operation procedure may implement a feature, such as for memory debugging or usage, that is not available through the firmware). In particular, the firmware of the memory apparatus 204 may not be configured (e.g., programmed) with an operation that implements the specific combination of memory commands of the memory operation procedure as a single procedure. In contrast, the memory commands may be supported natively by the memory apparatus 204. For example, the memory commands may be supported by the firmware of the memory apparatus 204. In particular, the firmware of the memory apparatus 204 may be configured (e.g., programmed) with operations that implement the memory commands individually (e.g., but not as part of a single procedure). As an example, the memory commands may be vendor-defined commands or commands defined by a standards body, such as the Joint Electron Device Engineering Council (JEDEC). For example, the memory commands may include read, write, erase, status check, wear-leveling, block protection, and/or secure erase commands.

The host device 202 may construct the memory operation procedure dynamically using the plurality of memory commands. For example, rather than issuing to the memory apparatus 204 a single command that represents a procedure, the host device 202 may construct the memory operation procedure in real time (e.g., when the command is received by the host device 202) by combining the memory commands. In some implementations, the host device 202 may identify a sequence of the memory commands (e.g., which may be indicated in a configuration for the memory operation procedure provided in the application), and the host device 202 may construct the memory operation procedure in accordance with the sequence.

In some implementations, the memory operation procedure may be configured to address (e.g., resolve) a faultiness (e.g., a bug or other issue) in the firmware of the memory apparatus 204 (e.g., the memory operation procedure may provide a workaround for a bug or other issue). For example, the memory operation procedure may modify a status or an operational state of the memory apparatus 204, in order to provide a safe operating state for the memory apparatus 204 (e.g., an operating state that prevents or mitigates platform failure, data loss, and/or data corruption). In some implementations, the memory operation procedure may be configured to obtain particular information from the memory apparatus 204 that can be used for diagnostics or similar purposes.

As shown by reference number 210, the host device 202 (e.g., using the application) may transmit, and the memory apparatus 204 may receive, the plurality of memory commands of the memory operation procedure (e.g., on a bus from the host device 202 to the memory apparatus 204). In some implementations, the host device 202 may transmit the memory commands in accordance with the sequence identified for the memory commands. In some implementations, the host device 202 may transmit the memory commands sequentially (e.g., whether or not according to a particular sequence) with or without awaiting response from the memory apparatus 204 after each of the memory commands is transmitted. In some implementations, the host device 202 may transmit the memory commands concurrently (e.g., in parallel or as part of a single instruction) such that no responses from the memory apparatus 204 can be transmitted between memory commands.

In some implementations, the host device 202 may transmit, and the memory apparatus 204 may receive, one or more first memory commands of the memory operation procedure (e.g., as a first step of the memory operation procedure). The memory apparatus 204 may execute the first memory commands, and the memory apparatus 204 may transmit, and the host device 202 may receive, one or more initial responses relating to an execution of the first memory commands. Based on the initial responses, the host device 202 may determine one or more second memory commands of the memory operation procedure that are to be executed by the memory apparatus 204. For example, if the initial responses include a first indication or first information, then the host device 202 may determine (e.g., select) a particular memory command that is to be executed by the memory apparatus 204. In some implementations, the host device 202 may process the first indication or the first information to generate data (e.g., diagnostic data, analytics data, or the like), and the host device may determine (e.g., select) the particular memory command in accordance with the data (e.g., based on an analysis of the data). Continuing with the example, if the initial responses include a second indication or second information, then the host device 202 may determine (e.g., select) a different particular memory command that is to be executed by the memory apparatus 204. Based on determining the second memory commands, the host device 202 may transmit, and the memory apparatus 204 may receive the second memory commands (e.g., as a second step of the memory operation procedure).

As shown by reference number 212, the memory apparatus 204 may execute the memory commands of the memory operation procedure (e.g., as a single memory operation procedure, or as multiple steps of the memory operation procedure). For example, the memory apparatus 204 may execute the memory commands as it would execute any memory command natively supported by the memory apparatus 204. In some implementations, the memory apparatus 204 may execute the memory commands in the sequence in which the memory commands were received by the memory apparatus 204. In some implementations, execution of the memory commands may cause the memory apparatus 204 to retrieve or gather information stored by the memory apparatus 204 in accordance with the memory commands (e.g., the memory commands may command particular data to be read from the memory apparatus 204). In some implementations, execution of the memory commands may cause the memory apparatus 204 to modify a status or an operational state of the memory apparatus 204 in accordance with the memory commands (e.g., the memory commands may command particular data to be written to the memory apparatus 204), which can address a fault in the firmware of the memory apparatus 204 and/or enable a safe operating state for the memory apparatus 204.

As shown by reference number 214, the memory apparatus 204 may transmit, and the host device 202 (e.g., using the application) may receive, a plurality of responses (e.g., feedback) relating to execution of the memory commands by the memory apparatus 204. In some implementations, the responses may indicate information from (e.g., retrieved from) the memory apparatus 204 in connection with execution of the memory commands, which can be used for diagnostics or similar purposes. For example, the information may include virtual blocks information (e.g., a set of parameters indicating a “dirtiness” of the memory apparatus 204) or other information (e.g., parameters) relating to a state, a performance, and/or a capacity, among other examples, of the memory apparatus 204. The host device 202 may map the information to the memory commands transmitted by the host device 202 (e.g., according to the sequence in which the memory commands were transmitted) in order to identify respective parts of the information (e.g., respective parameters) that are responsive to the respective memory commands that were transmitted. In some implementations, the responses may indicate successful execution (or in some cases, failure) of the memory commands by the memory apparatus 204. For example, the responses may indicate that a status or an operational state of the memory apparatus 204 has been modified in accordance with the memory commands, that a faultiness of the firmware of the memory apparatus 204 has been addressed (e.g., patched) in accordance with the memory commands, or the like. In this way, memory commands of the firmware of the memory apparatus 204 may be used without exposing sensitive information relating to firmware structures to a user of the application.

As shown by reference number 216, the host device 202 (e.g., using the application) may generate an output in accordance with the responses from the memory apparatus 204. For example, the application may process or otherwise use the responses to generate an output that can be consumed by other applications or systems of the host device 202. In some implementations, if the responses from the memory apparatus 204 merely indicate successful execution of the memory commands, the host device 202 may generate an output indicating completion of the memory operation procedure. In some implementations, if the responses from the memory apparatus 204 indicate information from the memory apparatus 204, the host device 202 (e.g., using the application) may analyze the information (e.g., may perform one or more computations using the information). Moreover, based on analyzing the information, the host device 202 may generate diagnostic data relating to the memory apparatus 204. For example, the diagnostic data may facilitate troubleshooting or optimizing a performance of the memory apparatus 204.

By decoupling the memory operation procedures from the firmware, techniques described herein increase the adaptability of a system to changes or additions of functionalities without requiring comprehensive firmware overhauls. Moreover, techniques described herein enable efficient deployment of updates to quickly address known bugs or issues in firmware.

As indicated above, FIG. 2 is provided as an example. Other examples may differ from what is described with regard to FIG. 2.

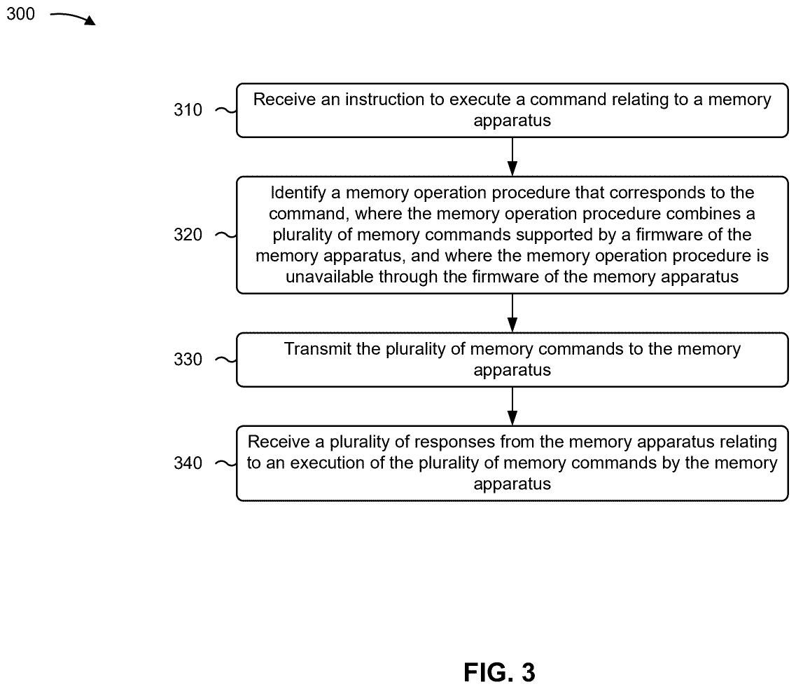

FIG. 3 is a flowchart of an example method 300 associated with host-implemented memory operation procedures. In some implementations, a host system (e.g., the host system 105) may perform or may be configured to perform the method 300. In some implementations, another device or a group of devices separate from or including the host system (e.g., the memory system 110) may perform or may be configured to perform the method 300. Additionally, or alternatively, one or more components of the host system (e.g., host processor 150) may perform or may be configured to perform the method 300. Thus, means for performing the method 300 may include the host system and/or one or more components of the host system. Additionally, or alternatively, a non-transitory computer-readable medium may store one or more instructions that, when executed by the host system, cause the host system to perform the method 300.

As shown in FIG. 3, the method 300 may include receiving an instruction to execute a command relating to a memory apparatus (block 310). As further shown in FIG. 3, the method 300 may include identifying a memory operation procedure that corresponds to the command, where the memory operation procedure combines a plurality of memory commands supported by a firmware of the memory apparatus, and where the memory operation procedure is unavailable through the firmware of the memory apparatus (block 320). As further shown in FIG. 3, the method 300 may include transmitting the plurality of memory commands to the memory apparatus (block 330). As further shown in FIG. 3, the method 300 may include receiving a plurality of responses from the memory apparatus relating to an execution of the plurality of memory commands by the memory apparatus (block 340).

The method 300 may include additional aspects, such as any single aspect or any combination of aspects described below and/or described in connection with one or more other methods or operations described elsewhere herein.

In a first aspect, identifying the plurality of memory commands includes identifying a sequence of the plurality of memory commands, and transmitting the plurality of memory commands includes transmitting the plurality of memory commands in accordance with the sequence.

In a second aspect, alone or in combination with the first aspect, transmitting the plurality of memory commands includes transmitting one or more first memory commands of the plurality of memory commands to the memory apparatus, receiving one or more initial responses from the memory apparatus relating to an execution of the one or more first memory commands by the memory apparatus, determining, in accordance with the one or more initial responses, one or more second memory commands of the plurality of memory commands that are to be transmitted to the memory apparatus, and transmitting the one or more second memory commands to the memory apparatus.

In a third aspect, alone or in combination with one or more of the first and second aspects, the plurality of responses include information from the memory apparatus.

In a fourth aspect, alone or in combination with one or more of the first through third aspects, the method 300 includes generating diagnostic data using the information.

In a fifth aspect, alone or in combination with one or more of the first through fourth aspects, the plurality of responses indicate successful execution of the plurality of memory commands by the memory apparatus.

In a sixth aspect, alone or in combination with one or more of the first through fifth aspects, the method 300 includes generating an output indicating completion of the memory operation procedure.

In a seventh aspect, alone or in combination with one or more of the first through sixth aspects, the memory operation procedure is to address a faultiness in the firmware of the memory apparatus.

In an eighth aspect, alone or in combination with one or more of the first through seventh aspects, the memory operation procedure is to modify a status or an operational state of the memory apparatus.

In a ninth aspect, alone or in combination with one or more of the first through eighth aspects, the memory apparatus includes an mNAND memory device.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

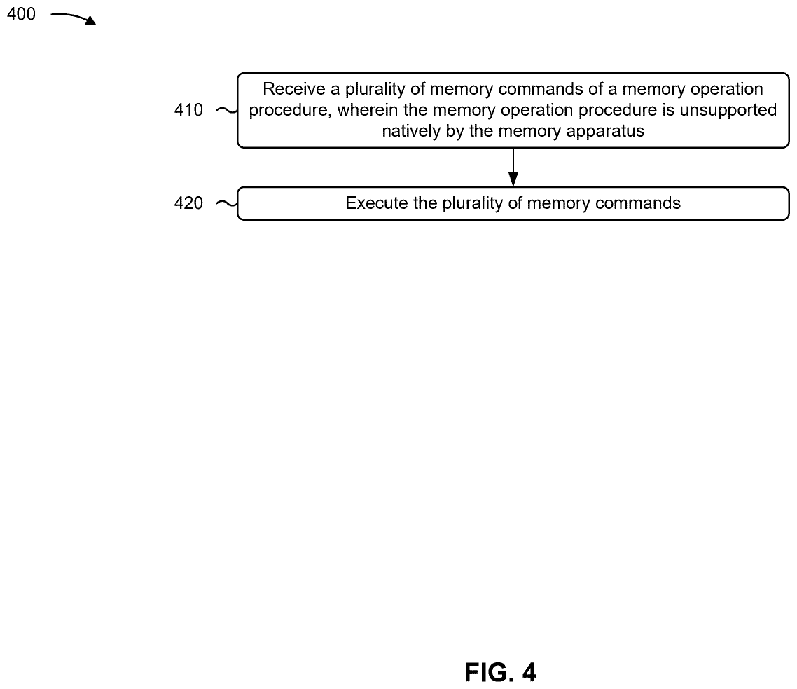

FIG. 4 is a flowchart of an example method 400 associated with host-implemented memory operation procedures. In some implementations, a memory system (e.g., the memory system 110) may perform or may be configured to perform the method 400. In some implementations, another device or a group of devices separate from or including the memory system (e.g., the host system 105) may perform or may be configured to perform the method 400. Additionally, or alternatively, one or more components of the memory system (e.g., memory system controller 115, memory device 120, and/or local controller 125) may perform or may be configured to perform the method 400. Thus, means for performing the method 400 may include the memory system and/or one or more components of the memory system. Additionally, or alternatively, a non-transitory computer-readable medium may store one or more instructions that, when executed by the memory system, cause the memory system to perform the method 400.

As shown in FIG. 4, the method 400 may include receiving a plurality of memory commands of a memory operation procedure, where the memory operation procedure is unsupported natively by the memory apparatus (block 410). As further shown in FIG. 4, the method 400 may include executing the plurality of memory commands (block 420).

The method 400 may include additional aspects, such as any single aspect or any combination of aspects described below and/or described in connection with one or more other methods or operations described elsewhere herein.

In a first aspect, the method 400 includes transmitting a plurality of responses relating to an execution of the plurality of memory commands.

In a second aspect, alone or in combination with the first aspect, the plurality of responses include information from the memory apparatus.

In a third aspect, alone or in combination with one or more of the first and second aspects, the plurality of responses indicate successful execution of the plurality of memory commands by the memory apparatus.

In a fourth aspect, alone or in combination with one or more of the first through third aspects, the memory operation procedure is to address a faultiness in a firmware of the memory apparatus.

In a fifth aspect, alone or in combination with one or more of the first through fourth aspects, executing the plurality of memory commands includes modifying, in accordance with the plurality of memory commands, a status or an operational state of the memory device.

In a sixth aspect, alone or in combination with one or more of the first through fifth aspects, receiving the plurality of memory commands includes receiving the plurality of memory commands sequentially.

In a seventh aspect, alone or in combination with one or more of the first through sixth aspects, receiving the plurality of memory commands includes receiving one or more first memory commands of the plurality of memory commands, transmitting one or more initial responses relating to an execution of the one or more first memory commands, and receiving one or more second memory commands of the plurality of memory commands.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a host system includes a host processor configured to: receive an instruction to execute a command relating to a memory apparatus; identify a memory operation procedure that corresponds to the command, wherein the memory operation procedure combines a plurality of memory commands supported by a firmware of the memory apparatus, and wherein the memory operation procedure is unavailable through the firmware of the memory apparatus; transmit the plurality of memory commands to the memory apparatus; and receive a plurality of responses from the memory apparatus relating to an execution of the plurality of memory commands by the memory apparatus.

In some implementations, a method includes receiving, by a host device, an instruction to execute a command relating to a memory apparatus; transmitting, by the host device and to the memory apparatus, a plurality of memory commands of a memory operation procedure corresponding to the command, wherein the memory operation procedure is unsupported natively by the memory apparatus, and wherein the plurality of memory commands are supported natively by the memory apparatus; and receiving, by the host device, a plurality of responses from the memory apparatus relating to an execution of the plurality of memory commands by the memory apparatus.

In some implementations, a system comprises: a host device configured to: receive an instruction to execute a command; identify a memory operation procedure that corresponds to the command, wherein the memory operation procedure combines a plurality of memory commands; and transmit the plurality of memory commands; and a memory apparatus, communicatively coupled to the host device, configured to: receive the plurality of memory commands; execute the plurality of memory commands; and transmit a plurality of responses relating to an execution of the plurality of memory commands.

In some implementations, an apparatus includes means for receiving an instruction to execute a command relating to a memory apparatus; means for transmitting, to the memory apparatus, a plurality of memory commands of a memory operation procedure corresponding to the command, wherein the memory operation procedure is unavailable through a firmware of the memory apparatus; means for receiving information from the memory apparatus relating to an execution of the plurality of memory commands by the memory apparatus; and means for analyzing the information to generate diagnostic data related to the memory apparatus.

In some implementations, a memory device includes one or more components configured to: receive, from a host device, a plurality of memory commands of a memory operation procedure, wherein the memory operation procedure is unsupported natively by the memory device; and execute the plurality of memory commands.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A host system, comprising:
a host processor configured to:
receive an instruction to execute a command relating to a memory apparatus;
identify a memory operation procedure that corresponds to the command,
wherein the memory operation procedure combines a plurality of memory commands supported by a firmware of the memory apparatus, and
wherein the memory operation procedure is unavailable through the firmware of the memory apparatus;
transmit the plurality of memory commands to the memory apparatus; and
receive a plurality of responses from the memory apparatus relating to an execution of the plurality of memory commands by the memory apparatus.

2. The host system of claim 1, wherein the host processor, to identify the plurality of memory commands, is configured to identify a sequence of the plurality of memory commands, and
wherein the host processor, to transmit the plurality of memory commands, is configured to transmit the plurality of memory commands in accordance with the sequence.

3. The host system of claim 1, wherein the host processor, to transmit the plurality of memory commands, is configured to:
transmit one or more first memory commands of the plurality of memory commands to the memory apparatus;
receive one or more initial responses from the memory apparatus relating to an execution of the one or more first memory commands by the memory apparatus;
determine, in accordance with the one or more initial responses, one or more second memory commands of the plurality of memory commands that are to be transmitted to the memory apparatus; and
transmit the one or more second memory commands to the memory apparatus.

4. The host system of claim 1, wherein the plurality of responses include information from the memory apparatus.

5. The host system of claim 4, wherein the host processor is further configured to:
generate diagnostic data using the information.

6. The host system of claim 1, wherein the plurality of responses indicate successful execution of the plurality of memory commands by the memory apparatus.

7. The host system of claim 6, wherein the host processor is further configured to:
generate an output indicating completion of the memory operation procedure.

8. The host system of claim 1, wherein the memory operation procedure is to address a faultiness in the firmware of the memory apparatus.

9. The host system of claim 1, wherein the memory operation procedure is to modify a status or an operational state of the memory apparatus.

10. The host system of claim 1, wherein the memory apparatus includes a managed NAND (mNAND) memory device.

11. A method, comprising:
receiving, by a host device, an instruction to execute a command relating to a memory apparatus;
transmitting, by the host device and to the memory apparatus, a plurality of memory commands of a memory operation procedure corresponding to the command,
wherein the memory operation procedure is unsupported natively by the memory apparatus, and
wherein the plurality of memory commands are supported natively by the memory apparatus; and
receiving, by the host device, a plurality of responses from the memory apparatus relating to an execution of the plurality of memory commands by the memory apparatus.

12. The method of claim 11, further comprising:
identifying the memory operation procedure corresponding to the command.

13. The method of claim 11, wherein transmitting the plurality of memory commands comprises:
transmitting the plurality of memory commands sequentially without awaiting response from the memory apparatus after each of the plurality of memory commands.

14. The method of claim 11, wherein transmitting the plurality of memory commands comprises:
transmitting one or more first memory commands of the plurality of memory commands;
receiving one or more initial responses from the memory apparatus relating to an execution of the one or more first memory commands by the memory apparatus;
determining, based on the one or more initial responses, one or more second memory commands of the plurality of memory commands to be executed by the memory apparatus; and
transmitting the one or more second memory commands to the memory apparatus.

15. The method of claim 11, wherein the memory operation procedure is configured in an application executing on the host device.

16. The method of claim 11, further comprising:
constructing the memory operation procedure dynamically using the plurality of memory commands.

17. The method of claim 11, wherein the memory operation procedure is to enable a safe operating state for the memory apparatus.

18. A system comprising:
a host device configured to:
receive an instruction to execute a command;
identify a memory operation procedure that corresponds to the command,
wherein the memory operation procedure combines a plurality of memory commands; and
transmit the plurality of memory commands; and
a memory apparatus, communicatively coupled to the host device, configured to:
receive the plurality of memory commands;
execute the plurality of memory commands; and
transmit a plurality of responses relating to an execution of the plurality of memory commands.

19. The system of claim 18, wherein the memory operation procedure is a non-native operation of the memory apparatus.

20. The system of claim 18, wherein the memory operation procedure is unavailable through a firmware of the memory apparatus.

21. The system of claim 20, wherein the plurality of memory commands are supported by the firmware of the memory apparatus.

22. The system of claim 18, wherein the plurality of responses include information from the memory apparatus, and
wherein the host device is further configured to:
generate diagnostic data using the information.

23. The system of claim 18, wherein the memory apparatus includes a managed NAND (mNAND) memory device.

24. An apparatus, comprising:
means for receiving an instruction to execute a command relating to a memory apparatus;
means for transmitting, to the memory apparatus, a plurality of memory commands of a memory operation procedure corresponding to the command,
wherein the memory operation procedure is unavailable through a firmware of the memory apparatus;
means for receiving information from the memory apparatus relating to an execution of the plurality of memory commands by the memory apparatus; and
means for analyzing the information to generate diagnostic data related to the memory apparatus.

25. The apparatus of claim 24, further comprising:
means for identifying the memory operation procedure corresponding to the command.

26. The apparatus of claim 24, wherein the plurality of memory commands are supported by the firmware of the memory apparatus.

27. The apparatus of claim 24, wherein the memory operation procedure is to modify a status or an operational state of the memory apparatus.

28. A memory device, comprising:
one or more components configured to:
receive, from a host device, a plurality of memory commands of a memory operation procedure,
wherein the memory operation procedure is unsupported natively by the memory device; and
execute the plurality of memory commands.

29. The memory device of claim 28, wherein the one or more components are further configured to:
transmit a plurality of responses relating to an execution of the plurality of memory commands.

30. The memory device of claim 29, wherein the plurality of responses include information from the memory device.

31. The memory device of claim 29, wherein the plurality of responses indicate successful execution of the plurality of memory commands by the memory device.

32. The memory device of claim 28, wherein the memory operation procedure is to address a faultiness in a firmware of the memory device.

33. The memory device of claim 28, wherein the one or more components, to execute the plurality of memory commands, are configured to:
modify, in accordance with the plurality of memory commands, a status or an operational state of the memory device.

34. The memory device of claim 28, wherein the one or more components, to receive the plurality of memory commands, are configured to:
receive the plurality of memory commands sequentially.

35. The memory device of claim 28, wherein the one or more components, to receive the plurality of memory commands, are configured to:
receive one or more first memory commands of the plurality of memory commands;
transmit one or more initial responses relating to an execution of the one or more first memory commands; and
receive one or more second memory commands of the plurality of memory commands.
